(19) United States
(12) Patent Application Publication
(10) Pub. No.: US 2026/0091332 A1
(43) Pub. Date: Apr. 2, 2026

(54) TOOL-FREE WATER FILTER

(71) Applicant: KEMFLO INTERNATIONAL CO., LTD., Pingtung City (TW)

(72) Inventors: Sheng-Nan Lin, Pingtung City (TW); Hui-Chou Lin, Pingtung City (TW)

(21) Appl. No.: 18/901,570

(22) Filed: Sep. 30, 2024

(51) Int. Cl. B01D 35/30; B01D 35/147

(52) U.S. Cl. CPC B01D 35/30; B01D 35/1475; B01D 2201/302; B01D 2201/4084

(57) ABSTRACT

A water filter includes a cover assembly having a filtering head, a filter bottle assembly having a filter bottle, and a connecting device connecting the filtering head and the filter bottle. The connecting device includes a fastening module, a rotation wheel mechanism, a rotary member, and a pulling member. The fastening module includes a tightening strap, a pivot seat, and multiple elastic support pieces. The rotation wheel mechanism includes a drive module and a rotation wheel engaging the drive module so that the rotation wheel and the drive module are linked. The pulling member presses the tightening strap and the pivot seat. The pulling member encircles the elastic support pieces and is wound around the rotation wheel so that the pulling member is scrolled by rotation of the rotation wheel, and the elastic support pieces are compressed by the pulling member.

### BACKGROUND OF THE INVENTION

### Field of the Invention

The present invention relates to a water filter and, more particularly, to a full-house leading water filter that is mounted on a main pipeline before entering a house.

### Description of the Related Art

A conventional water filter or purifier has a POE (point of entry) filtering mode and comprises a filtering head and a filter bottle. The filter bottle contains a filter element and is connected with the filtering head. When the user wishes to replace the filter element, the water source has to be shut previously, and the filter bottle is rotated by a wrench to detach the filter bottle from the filtering head. However, the water easily leaks outward during replacement of the filter element if the user forgets to shut the water source. In addition, when the filter bottle is rotated by the wrench to an excess extent, the filter bottle easily falls after being detached from the filtering head, thereby causing danger to the user. Another conventional water filter further comprises a cam sliding rail (or track) which is rotated to mount or detach the filter bottle. However, the cam sliding rail has a complicated structure and is exposed from the filtering head so that the cam sliding rail is easily hooked or torn by the user. In addition, the filter bottle easily falls down after being detached from the filtering head.

### BRIEF SUMMARY OF THE INVENTION

The primary objective of the present invention is to provide a tool-free water filter whose filter bottle is assembled and disassembled easily and rapidly without needing tools.

In accordance with the present invention, there is provided a water filter comprising a cover assembly, a filter bottle assembly mounted on the cover assembly, and a connecting device connecting the cover assembly and the filter bottle assembly. The cover assembly includes a filtering head, a top cover mounted on the filtering head, and a switching module mounted on the top cover. The filtering head is provided with a water inlet and a water outlet. The filtering head has a bottom provided with a first embedded groove. The filter bottle assembly includes a filter bottle removably mounted on the filtering head. The filter bottle has an upper end provided with a second embedded groove. The filter bottle has an interior provided with a first receiving space and a second receiving space. The connecting device includes a fastening module, a rotation wheel mechanism, a rotary member, and a pulling member. The fastening module includes a tightening strap having an annular shape, a pivot seat connected with the tightening strap, and multiple elastic support pieces encompassed by the tightening strap. The tightening strap has an upper end provided with a first snap-fit portion locked in the first embedded groove and a second snap-fit portion locked in the second embedded groove. The pivot seat has a first shaft and a second shaft connected to the first shaft. The first shaft has an interior provided with a ratchet wheel having multiple ratchet teeth and an exterior provided with a mounting portion. The second shaft is connected with the tightening strap so that the second shaft and the tightening strap are linked synchronously. The rotation wheel mechanism includes a drive module and a rotation wheel. The drive module is pivotally mounted in the first shaft and includes multiple elastic plates and multiple pawls. The pawls detachably and elastically engage the ratchet wheel and are reciprocally movable relative to the ratchet wheel. The rotation wheel is pivotally mounted in the second shaft. The rotation wheel engages the drive module so that the rotation wheel and the drive module are linked synchronously. The rotary member has a first embedded portion mounted on the mounting portion. The rotary member has a second embedded portion mounted on the drive module so that the drive module is driven by the rotary member. The pulling member is flexible and presses an inside of the tightening strap and the pivot seat. The pulling member encircles the elastic support pieces and has two ends secured to and wound around the rotation wheel so that the pulling member is scrolled by rotation of the rotation wheel, and the elastic support pieces are compressed by the pulling member. when the drive module is rotated by the rotary member, the pawls engage the ratchet wheel, so that the drive module is rotated in a one-way direction. The rotation wheel is driven by the drive module and is rotated in a one-way direction. The pulling member is tightened by rotation of the rotation wheel and compresses the elastic support pieces. The elastic support pieces compress the filtering head and the filter bottle, so that the filtering head and the filter bottle are locked by the elastic support pieces. when the rotary member is pulled outward, the drive module is moved with the rotary member and detached from the rotation wheel, so that the elastic support pieces are pushed outward, and the filtering head and the filter bottle are unlocked from the elastic support pieces.

### BRIEF DESCRIPTION OF THE SEVERAL VIEWS OF THE DRAWING(S)

FIG. 1 is a perspective view of a water filter in accordance with the preferred embodiment of the present invention.

FIG. 2 is a side cross-sectional view of the water filter as shown in FIG. 1.

FIG. 3 is a front cross-sectional view of the water filter as shown in FIG. 1.

FIG. 4 is a locally enlarged front view of the water filter as shown in FIG. 1.

FIG. 5 is an exploded perspective view of the water filter in accordance with the preferred embodiment of the present invention.

FIG. 6 is a partial exploded perspective view of the water filter in accordance with the preferred embodiment of the present invention.

FIG. 7 is a partial exploded perspective view of the water filter in accordance with the preferred embodiment of the present invention.

FIG. 8 is a partial exploded perspective view of the water filter in accordance with the preferred embodiment of the present invention.

FIG. 9 is a cross-sectional view showing a filtering mode of the water filter in accordance with the preferred embodiment of the present invention.

FIG. 10 is a cross-sectional view showing a replacement mode of the water filter in accordance with the preferred embodiment of the present invention.

FIG. 11 is a cross-sectional view showing a first operational state of the water filter in accordance with the preferred embodiment of the present invention.

FIG. 12 is a cross-sectional view showing a second operational state of the water filter in accordance with the preferred embodiment of the present invention.

### DETAILED DESCRIPTION OF THE INVENTION

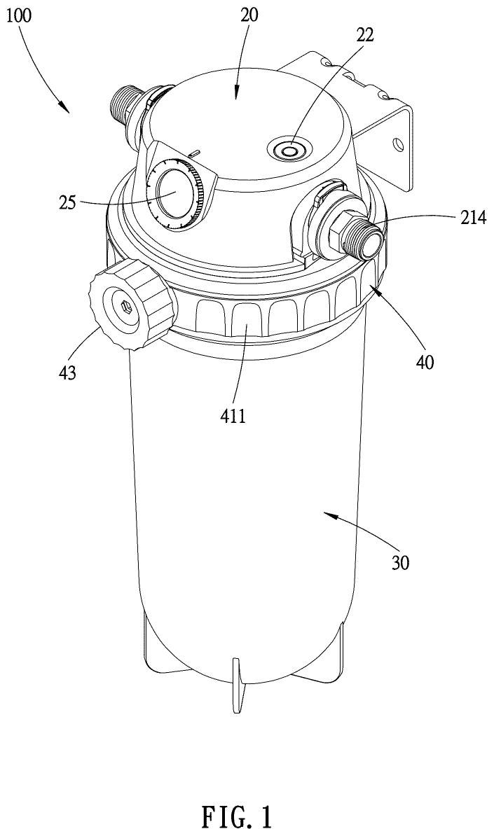

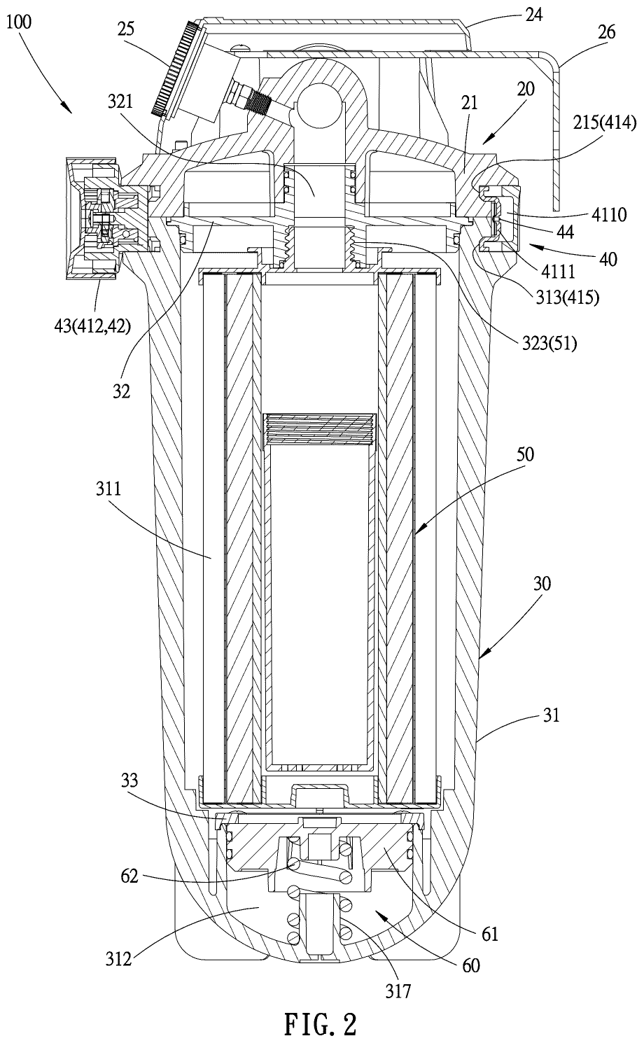

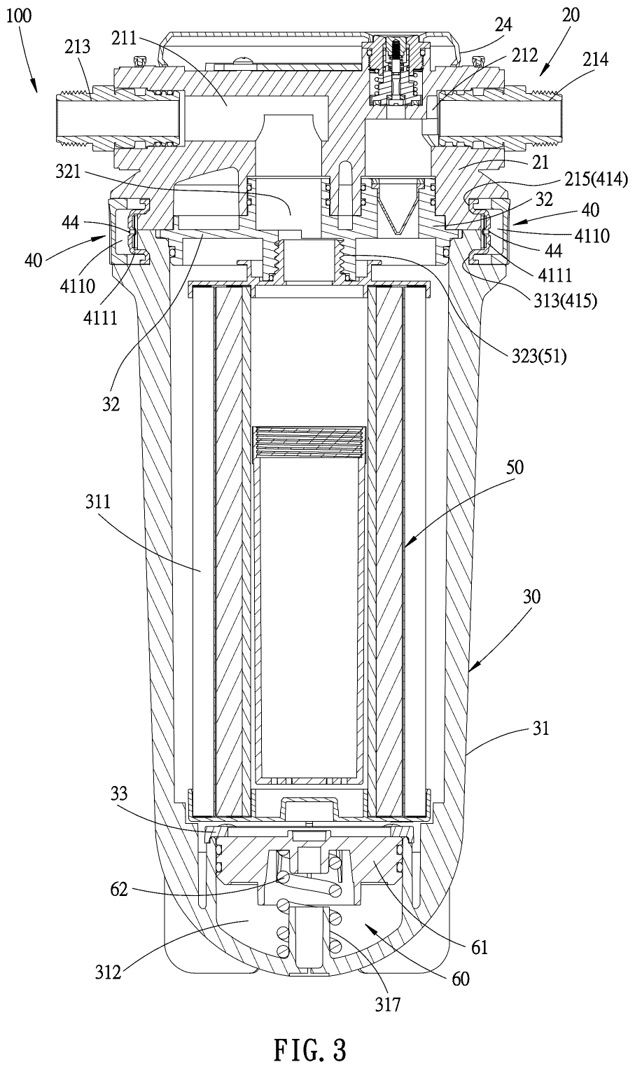

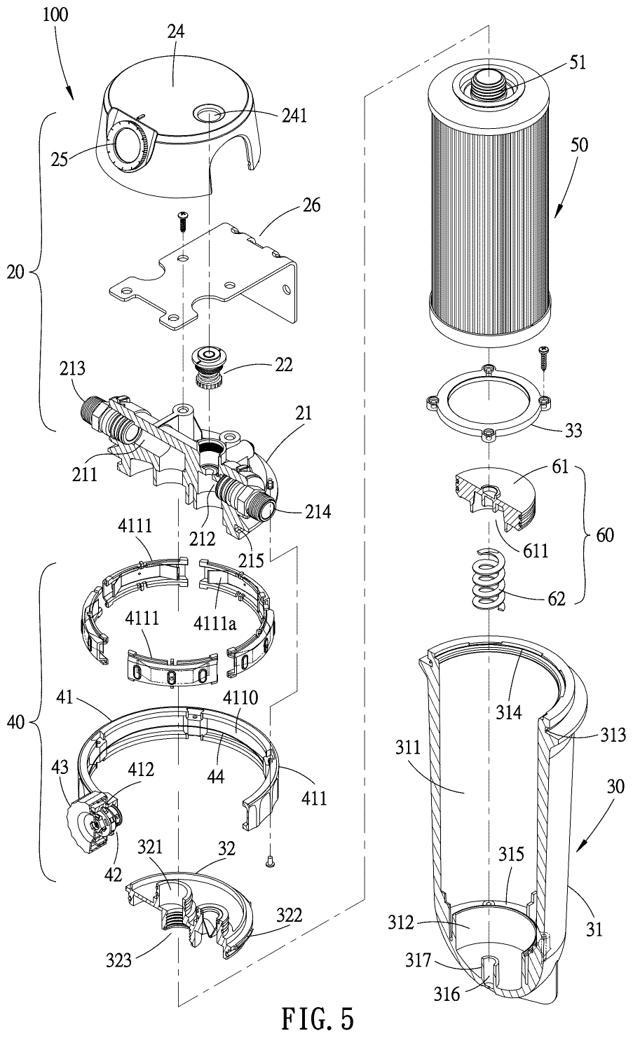

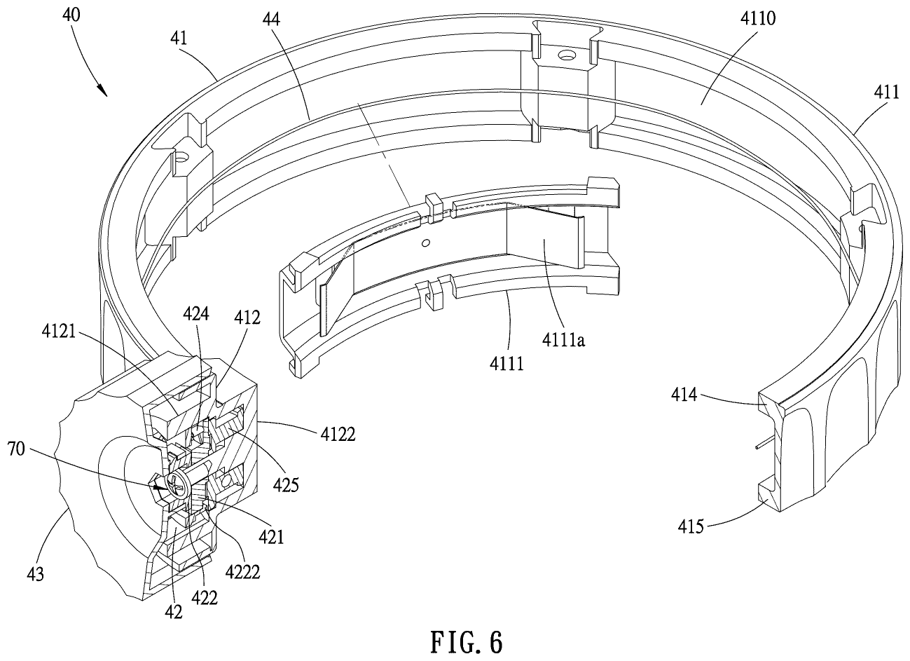

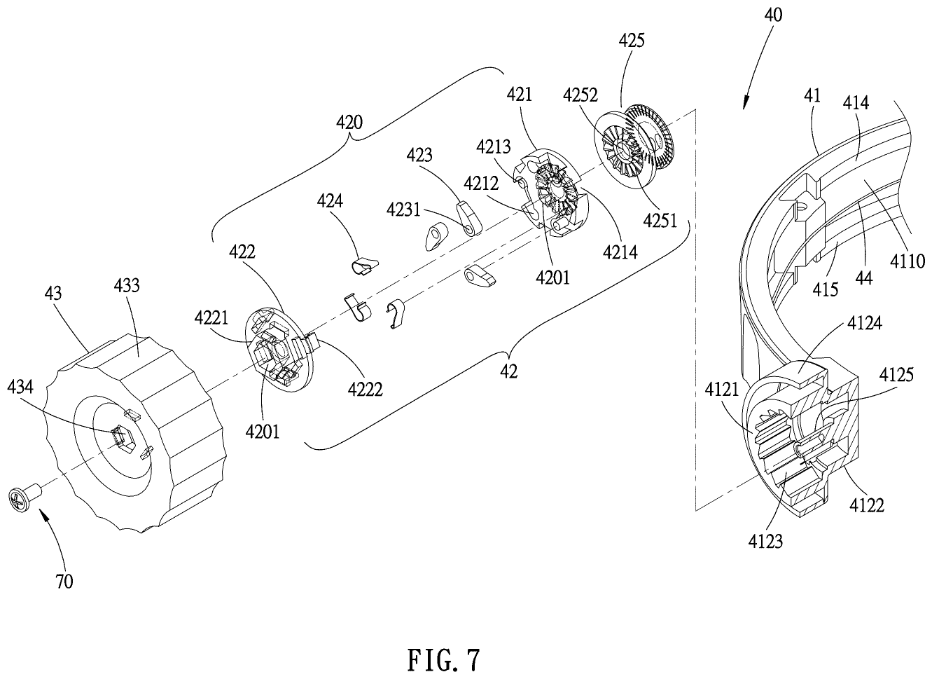

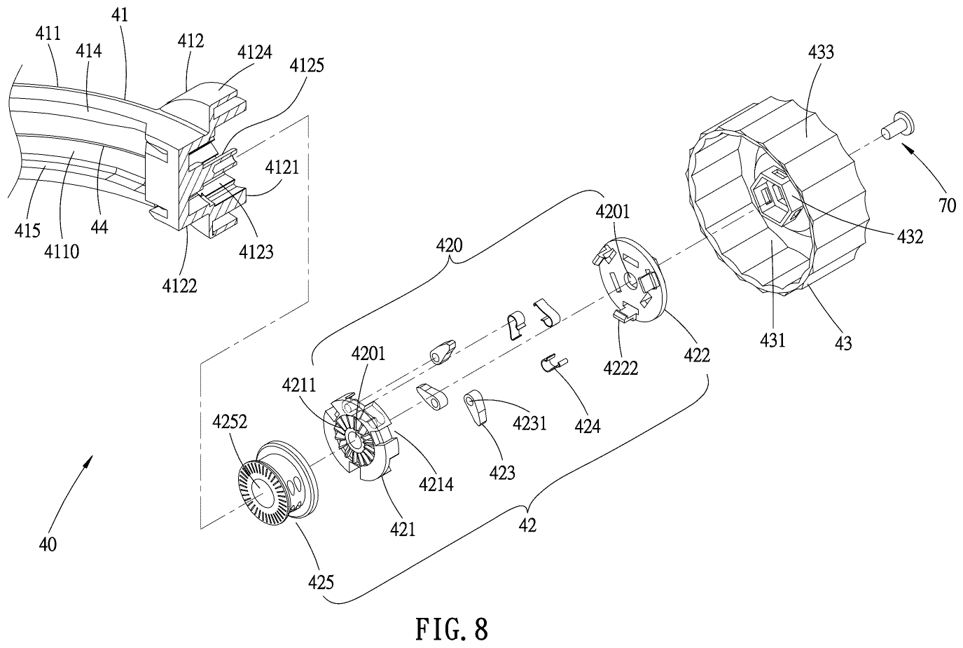

Referring to the drawings and initially to FIGS. 1-8, a water filter (or purifier) 100 in accordance with the preferred embodiment of the present invention comprises a cover assembly 20, a filter bottle assembly 30 mounted on the cover assembly 20, and a connecting device 40 connecting the cover assembly 20 and the filter bottle assembly 30.

The cover assembly 20 includes a filtering head 21, a top cover 24 mounted on and covering the filtering head 21, and a switching module (or water valve module) 25 mounted on the top cover 24.

The filtering head 21 is provided with a water inlet 211 and a water outlet 212 connected to the water inlet 211. The water inlet 211 and the water outlet 212 construct a waterway (or water channel). The filtering head 21 has a bottom provided with a first embedded groove 215.

The filter bottle assembly 30 includes a filter bottle (or container) 31 removably mounted on the filtering head 21. The filter bottle 31 has an open upper end provided with a second embedded groove 313 opposite to the first embedded groove 215. The filter bottle 31 has an interior provided with a first receiving space 311 and a second receiving space 312.

The connecting device 40 includes a fastening (or binding or pressing) module 41, a rotation wheel mechanism 42, a rotary member 43, and a pulling (or drawing) member 44.

The fastening module 41 includes a tightening strap 411 having an annular shape, a pivot seat 412 connected with the tightening strap 411, and multiple elastic support pieces 4111 encompassed by the tightening strap 411.

The tightening strap 411 is elastic and has an upper end provided with a first snap-fit portion 414 locked in the first embedded groove 215 of the filtering head 21 and a second snap-fit portion 415 locked in the second embedded groove 313 of the filter bottle 31.

The pivot seat 412 has a first shaft 4121 and a second shaft 4122 connected to the first shaft 4121. The first shaft 4121 has an interior provided with a ratchet wheel 4123 having multiple ratchet teeth and an exterior provided with a mounting portion 4124 extending outward. Preferably, the mounting portion 4124 has an annular groove. The second shaft 4122 is connected with the tightening strap 411 so that the second shaft 4122 and the tightening strap 411 are linked synchronously.

The elastic support pieces 4111 extend into the first embedded groove 215 of the filtering head 21 and the second embedded groove 313 of the filter bottle 31.

The rotation wheel mechanism 42 includes a drive module 420 and a rotation wheel 425. The drive module 420 is pivotally mounted in the first shaft 4121 of the pivot seat 412 and includes multiple elastic plates 424 and multiple pawls 423. The pawls 423 of the drive module 420 detachably and elastically engage the ratchet wheel 4123 of the first shaft 4121 and are reciprocally movable relative to the ratchet wheel 4123 of the first shaft 4121.

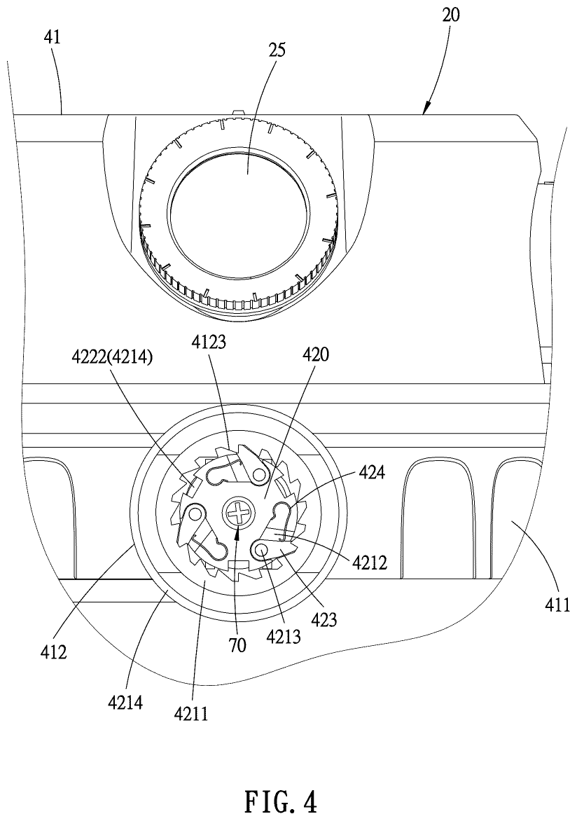

In practice, when the drive module 420 is rotated in the normal (or clockwise) direction as shown in FIG. 4, the pawls 423 passes the ratchet wheel 4123, and when the drive module 420 is rotated in the reverse (or counterclockwise) direction, the pawls 423 are locked by the ratchet wheel 4123, to stop rotation of the drive module 420, so that the drive module 420 is rotated relative to the first shaft 4121 in a one-way direction.

The rotation wheel 425 is pivotally mounted in the second shaft 4122 of the pivot seat 412. The rotation wheel 425 engages the drive module 420 so that the rotation wheel 425 and the drive module 420 are linked synchronously.

The rotary member 43 is mounted on the pivot seat 412 and has a first embedded portion 431 mounted on the mounting portion 4124 of the first shaft 4121. The rotary member 43 has a second embedded portion 432 mounted on the drive module 420 so that the drive module 420 is connected with and driven by the rotary member 43.

The pulling member 44 is flexible and presses an inside of the tightening strap 411 and the pivot seat 412. The pulling member 44 encircles an outside of the elastic support pieces 4111 and has two ends secured to and wound around the rotation wheel 425 so that the pulling member 44 is scrolled, tightened and pressed inward by rotation of the rotation wheel 425, and the elastic support pieces 4111 are compressed by the pulling member 44.

In the preferred embodiment of the present invention, the top cover 24 is provided with a through hole 241, and the cover assembly 20 further includes a pressure relief valve 22 mounted in the through hole 241 of the top cover 24. The pressure relief valve 22 includes a pressure relief button and a detector and has a preset pressure value to detect and release a pressure manually or automatically. When the detector detects the pressure exceeds the preset value, the pressure relief valve 22 is operated automatically to release the pressure. When the pressure relief button is pressed manually, the pressure in the filter bottle 31 is released to facilitate replacement of the filter bottle 31.

In the preferred embodiment of the present invention, the water filter 100 further comprises a filter element (or cartridge) 50 mounted in the filter bottle assembly 30 and provided with a flow channel, and the filter bottle assembly 30 further includes a first positioning plate 32 mounted in the filter bottle 31, and a second positioning plate 33 mounted in the filter bottle 31 and located under and parallel with the first positioning plate 32. The first receiving space 311 is defined between the first positioning plate 32 and the second positioning plate 33, and the second receiving space 312 is defined between the second positioning plate 33 and a bottom of the filter bottle 31. The filter element 50 is received in the first receiving space 311 and located between the first positioning plate 32 and the second positioning plate 33.

In the preferred embodiment of the present invention, the second receiving space 312 has a bottom provided with a protruding rib 317 having an air hole 316 connected to an ambient air. A water hammer arrester (or absorber) 60 is received in the second receiving space 312 and mounted on the protruding rib 317 to close the second receiving space 312. Thus, the first receiving space 311 and the second receiving space 312 are disconnected. The water hammer arrester 60 includes a piston 61 and a spring 62. The piston 61 rests on the second positioning plate 33 and is provided with a recess 611 for mounting the spring 62. The spring 62 is biased between the piston 61 and the protruding rib 317.

Thus, the second receiving space 312 contains air and the spring 62 to form a closed buffering zone to provide a damping function, and the first receiving space 311 form an open zone contacting a liquid pressure. When the water hammer phenomenon occurs, the interior of the filter bottle 31 is affected by the pressure, so that the piston 61 is vibrated upward and downward. At this time, the impact applied on the piston 61 is absorbed by the air and the spring 62 in the closed zone, to reduce the pressure in the filter bottle 31, and to prevent the filter bottle 31 from being broken.

In the preferred embodiment of the present invention, the elastic support pieces 4111 press an inside of the tightening strap 411. The elastic support pieces 4111 and the tightening strap 411 are connected to form an elastic support force. The fastening module 41 further includes multiple elastic sheets 4111a mounted on an inside of the elastic support pieces 4111 respectively and pressing the filtering head 21 and the filter bottle 31.

In the preferred embodiment of the present invention, the tightening strap 411 is provided with an embedded groove 4110, and the elastic support pieces 4111 are embedded into the embedded groove 4110.

In the preferred embodiment of the present invention, the ratchet teeth of the ratchet wheel 4123 have an oblique shape and engage the pawls 423 of the drive module 420.

In the preferred embodiment of the present invention, the drive module 420 is provided with a first abutting (or engaging) face 4211, and the rotation wheel 425 is provided with a second abutting (or engaging) face 4251 engaging the first abutting face 4211 so that the rotation wheel 425 and the drive module 420 are linked synchronously. The first abutting face 4211 of the drive module 420 has multiple oblique teeth, and the second abutting face 4251 of the rotation wheel 425 has multiple oblique teeth, to increase a friction resistance between the first abutting face 4211 of the drive module 420 and the second abutting face 4251, so that the rotation wheel 425 and the drive module 420 are rotated synchronously.

In the preferred embodiment of the present invention, the drive module 420 further includes a bottom disk 421 and a mounting cap 422 detachably assembled with the bottom disk 421. The bottom disk 421 is provided with multiple limit slots 4212 and multiple pins 4213 mounted in the limit slots 4212. The mounting cap 422 is provided with an embedded section 4221 inserted into the second embedded portion 432 of the rotary member 43.

In the preferred embodiment of the present invention, each of the pawls 423 is received in one of the limit slots 4212 and has a first end provided with a pivot hole 4231 pivotally mounted on one of the pins 4213 and a second end protruding from one of the limit slots 4212, and each of the elastic plates 424 is received in one of the limit slots 4212 and elastically biased between the bottom disk 421 and the second end of one of the pawls 423.

In the preferred embodiment of the present invention, the elastic support pieces 4111 form an arcuate C-shaped snap member matching the embedded groove 4110.

In the preferred embodiment of the present invention, the pulling member 44 is steel rope (or wire) and is disposed between the tightening strap 411 and the elastic support pieces 4111.

In the preferred embodiment of the present invention, the pulling member 44 is wound around the rotation wheel 425 through multiple circles.

In the preferred embodiment of the present invention, the pulling member 44 is wound in the tightening strap 411 and the pivot seat 412 through multiple circles.

In the preferred embodiment of the present invention, the filtering head 21 is provided with a water inlet connector 213 connected to the water inlet 211 and a water outlet connector 214 connected to the water outlet 212.

In the preferred embodiment of the present invention, the switching module 25 is connected to the water inlet 211 and the water outlet 212 of the filtering head 21.

In the preferred embodiment of the present invention, a mounting bracket 26 is mounted on a rear side of the filtering head 21 to hang or attach the water filter 100 to a working place, such as a wall, a table or the like.

In the preferred embodiment of the present invention, the filter bottle 31 is provided with a first insertion portion 314 for positioning the first positioning plate 32, and a second insertion portion 315 for positioning the second positioning plate 33.

In the preferred embodiment of the present invention, the first positioning plate 32 is provided with a connecting hole 321 connected to the flow channel of the filter element 50 and connected to the water inlet 211 and the water outlet 212. The first positioning plate 32 is provided with an insertion rib 322 positioned in the first insertion portion 314 of the filter bottle 31. The first positioning plate 32 is provided with a first locking portion 323 connected to the connecting hole 321, and the filter element 50 is provided with a second locking portion 51 locked on the first locking portion 323 of the first positioning plate 32. The first locking portion 323 has an inner thread, and the second locking portion 51 has an outer thread.

In the preferred embodiment of the present invention, the pivot seat 412 is provided with a central shaft 4125 passing through the first shaft 4121 and the second shaft 4122, and the rotation wheel mechanism 42 is pivotally mounted on the central shaft 4125.

In the preferred embodiment of the present invention, the drive module 420 has a center provided with a first perforation 4201, the rotation wheel 425 has a center provided with a second perforation 4252 aligning with the first perforation 4201, and the central shaft 4125 extends through the first perforation 4201 of the drive module 420 and the second perforation 4252 of the rotation wheel 425.

In the preferred embodiment of the present invention, the rotary member 43 has a center provided with a third perforation 434 aligning with the first perforation 4201 and the second perforation 4252, and a fastening member 70 extends through a spring, the third perforation 434, the first perforation 4201, and the second perforation 4252, and is screwed into the central shaft 4125, to restrict the rotary member 43 on the pivot seat 412. The spring is biased between the fastening member 70 and the rotary member 43 so that the rotary member 43 is pushed toward the pivot seat 412 by the elastic force of the spring.

In the preferred embodiment of the present invention, the bottom disk 421 is provided with a first snap-fit section 4214, and the mounting cap 422 is provided with a second snap-fit section 4222 snapped on the first snap-fit section 4214 of the bottom disk 421, so that the mounting cap 422 is detachably assembled with the bottom disk 421.

In the preferred embodiment of the present invention, the rotary member 43 has a periphery provided with multiple concave antiskid portions 433 arranged annularly.

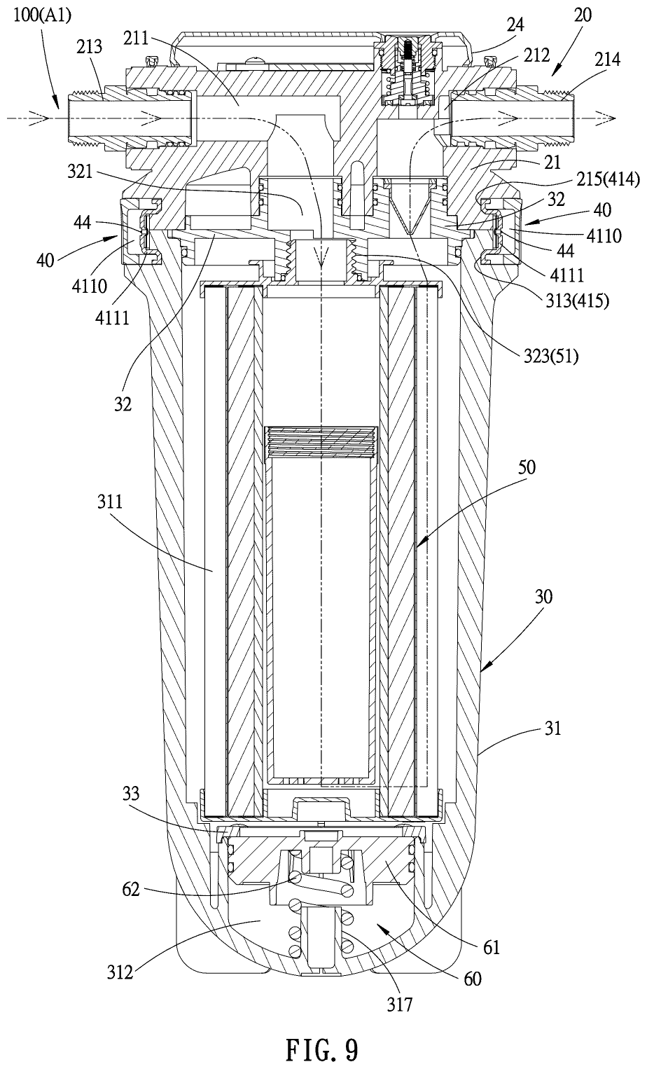

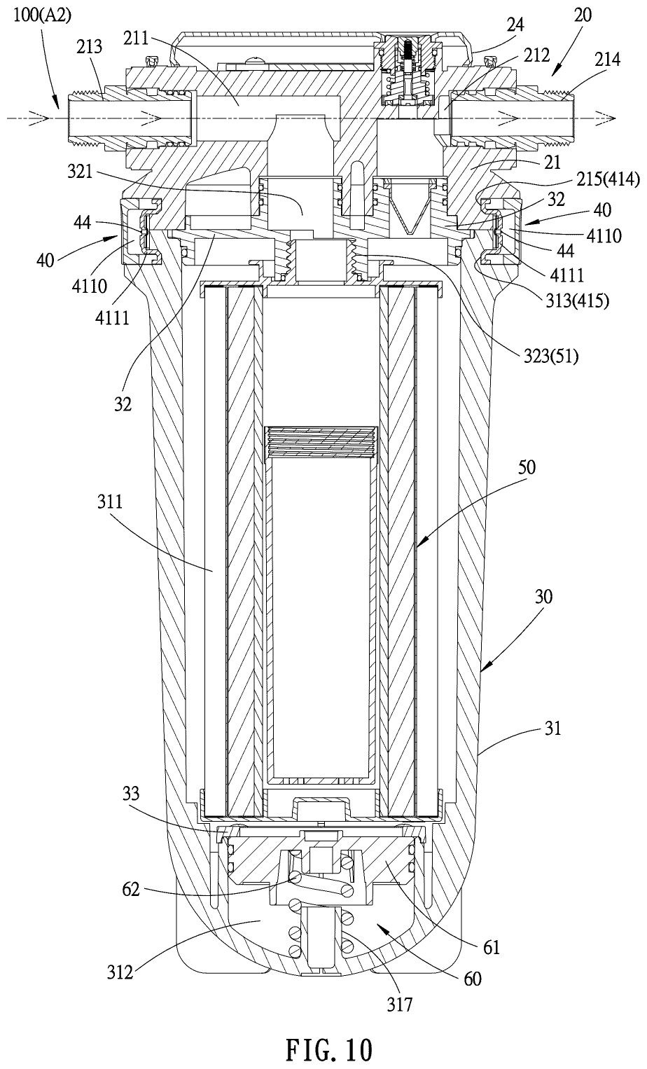

In practice, referring to FIGS. 9 and 10 with reference to FIGS. 1-8, when the switching module 25 is rotated, the switching module 25 is switched between a water purifying mode (or first flow path mode) A1 and a by-pass mode (or replacement mode or detachment mode or second flow path mode) A2. When the switching module 25 is rotated to the water purifying mode A1 as shown in FIG. 9, the switching module 25 is connected to the water inlet 211 and the water outlet 212, and is connected to the flow channel 321, so that ambient water flows through the water inlet 211, the switching module 25, and the connecting hole 321 into the flow channel of the filter element 50 which strains the water. Then, the purified water from the filter element 50 flows into the water outlet 212 and flows outward from the water outlet 212. Alternatively, when the switching module 25 is rotated to the by-pass mode A2 as shown in FIG. 10, the switching module 25 is connected to the water inlet 211 and the water outlet 212, and is disconnected from the flow channel of the filter element 50, so that the ambient water directly flows through the water inlet 211 into the water outlet 212 and flows outward from the water outlet 212. Thus, the switching module 25 is used to switch two water inlet modes including the water purifying mode A1 and the by-pass mode A2.

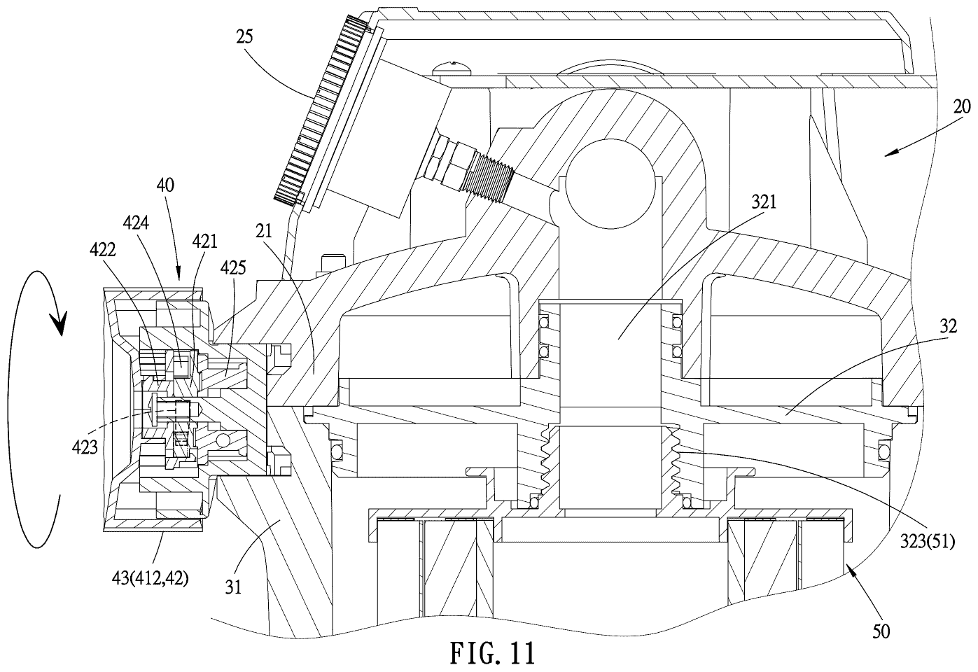

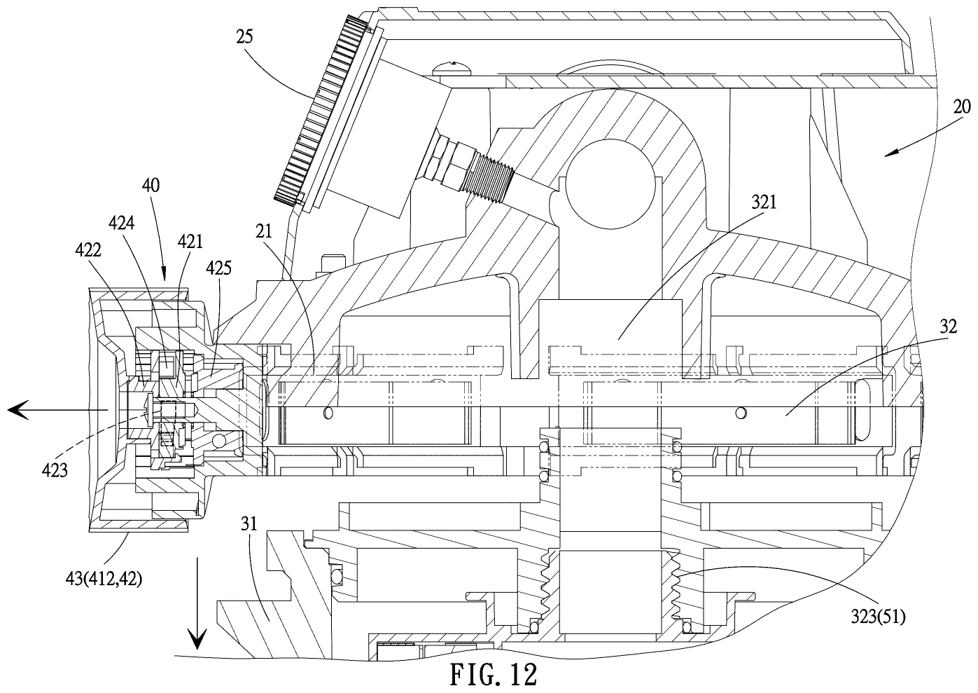

In operation, referring to FIGS. 11 and 12 with reference to FIGS. 1-8, when the drive module 420 is rotated by the rotary member 43 as shown in FIG. 11, the pawls 423 engage the ratchet wheel 4123, so that the drive module 420 is rotated in a one-way direction. The rotation wheel 425 is driven by the drive module 420 and is rotated in a one-way direction. The pulling member 44 is tightened by rotation of the rotation wheel 425 and compresses the elastic support pieces 4111 and the elastic sheets 4111a. The elastic support pieces 4111 compress the first embedded groove 215 of the filtering head 21 and the second embedded groove 313 of the filter bottle 31, so that the filtering head 21 and the filter bottle 31 are locked by the elastic support pieces 4111 of the connecting device 40. At this time, the elastic support pieces 4111 are pressed outward by the elastic sheets 4111a to force the pulling member 44 which forces the rotation wheel 425 which forces the drive module 420 which forces the pawls 423 which force the ratchet wheel 4123, to position the elastic support pieces 4111 and to prevent the elastic support pieces 4111 from being expanded outward.

On the contrary, when the rotary member 43 is pulled outward as shown in FIG. 12, the drive module 420 is moved with the rotary member 43 and detached from the rotation wheel 425, so that the elastic support pieces 4111 are pushed outward by a restoring force of the elastic sheets 4111a, and the filtering head 21 and the filter bottle 31 are unlocked from the elastic support pieces 4111. Thus, the first snap-fit portion 414 of the tightening strap 411 is detached from the first embedded groove 215 of the filtering head 21, and the second snap-fit portion 415 of the tightening strap 411 is detached from the second embedded groove 313 of the filter bottle 31, so that the filtering head 21 is detached from the filter bottle 31. At this time, the pulling member 44 is loosened by the elastic support pieces 4111, so that the rotation wheel 425 is driven by the pulling member 44 and rotated reversely.

Accordingly, the filter bottle 31 is directly mounted on or detached from the filtering head 21 by operation of the rotary member 43, so that the filter bottle 31 is assembled with and disassembled from the filtering head 21 easily and rapidly. In addition, the user directly assembles and disassembles the filter bottle 31 and the filtering head 21 without having to prepare any tool, thereby facilitating the user assembling and disassembling the filter bottle 31 and the filtering head 21. Further, the second receiving space 312 contains air and the spring 62 to form a closed buffering zone to provide a damping function. When the water hammer phenomenon occurs, the piston 61 is vibrated upward and downward, and the impact applied on the piston 61 is absorbed by the air and the spring 62 in the closed zone, to reduce the pressure in the filter bottle 31, and to prevent the filter bottle 31 from being broken.

1. A water filter comprising:
a cover assembly;
a filter bottle assembly mounted on the cover assembly; and
a connecting device connecting the cover assembly and the filter bottle assembly;
wherein:
the cover assembly includes a filtering head, a top cover mounted on the filtering head, and a switching module mounted on the top cover;
the filtering head is provided with a water inlet and a water outlet;
the filtering head has a bottom provided with a first embedded groove;
the filter bottle assembly includes a filter bottle removably mounted on the filtering head;
the filter bottle has an upper end provided with a second embedded groove;
the filter bottle has an interior provided with a first receiving space and a second receiving space;
the connecting device includes a fastening module, a rotation wheel mechanism, a rotary member, and a pulling member;
the fastening module includes a tightening strap having an annular shape, a pivot seat connected with the tightening strap, and multiple elastic support pieces encompassed by the tightening strap;
the tightening strap has an upper end provided with a first snap-fit portion locked in the first embedded groove and a second snap-fit portion locked in the second embedded groove;
the pivot seat has a first shaft and a second shaft connected to the first shaft;
the first shaft has an interior provided with a ratchet wheel having multiple ratchet teeth and an exterior provided with a mounting portion;
the second shaft is connected with the tightening strap so that the second shaft and the tightening strap are linked synchronously;
the rotation wheel mechanism includes a drive module and a rotation wheel;
the drive module is pivotally mounted in the first shaft and includes multiple elastic plates and multiple pawls;
the pawls detachably and elastically engage the ratchet wheel and are reciprocally movable relative to the ratchet wheel;
the rotation wheel is pivotally mounted in the second shaft;
the rotation wheel engages the drive module so that the rotation wheel and the drive module are linked synchronously;
the rotary member has a first embedded portion mounted on the mounting portion;
the rotary member has a second embedded portion mounted on the drive module so that the drive module is driven by the rotary member;
the pulling member is flexible and presses an inside of the tightening strap and the pivot seat;
the pulling member encircles the elastic support pieces and has two ends secured to and wound around the rotation wheel so that the pulling member is scrolled by rotation of the rotation wheel, and the elastic support pieces are compressed by the pulling member;
when the drive module is rotated by the rotary member, the pawls engage the ratchet wheel, so that the drive module is rotated in a one-way direction;
the rotation wheel is driven by the drive module and is rotated in a one-way direction;
the pulling member is tightened by rotation of the rotation wheel and compresses the elastic support pieces;
the elastic support pieces compress the filtering head and the filter bottle, so that the filtering head and the filter bottle are locked by the elastic support pieces; and
when the rotary member is pulled outward, the drive module is moved with the rotary member and detached from the rotation wheel, so that the elastic support pieces are pushed outward, and the filtering head and the filter bottle are unlocked from the elastic support pieces.

2. The water filter as claimed in claim 1, wherein the cover assembly further includes a pressure relief valve including a pressure relief button and a detector.

3. The water filter as claimed in claim 1, wherein:
the second receiving space has a bottom provided with a protruding rib having an air hole;
a water hammer arrester is received in the second receiving space and mounted on the protruding rib to close the second receiving space; and
the water hammer arrester includes a piston and a spring.

4. The water filter as claimed in claim 1, wherein:
the filter bottle assembly further includes a first positioning plate mounted in the filter bottle, and a second positioning plate mounted in the filter bottle;
the first receiving space is defined between the first positioning plate and the second positioning plate;
the second receiving space is defined between the second positioning plate and a bottom of the filter bottle; and
a filter element is received in the first receiving space and located between the first positioning plate and the second positioning plate.

5. The water filter as claimed in claim 1, wherein:
the elastic support pieces press an inside of the tightening strap;
the elastic support pieces and the tightening strap are connected to form an elastic support force; and
the fastening module further includes multiple elastic sheets mounted on the elastic support pieces respectively.

6. The water filter as claimed in claim 1, wherein the ratchet teeth of the ratchet wheel have an oblique shape and engage the pawls of the drive module.

7. The water filter as claimed in claim 1, wherein:
the drive module is provided with a first abutting face;
the rotation wheel is provided with a second abutting face engaging the first abutting face so that the rotation wheel and the drive module are linked synchronously;
the first abutting face has multiple oblique teeth; and
the second abutting face has multiple oblique teeth.

8. The water filter as claimed in claim 1, wherein:
the drive module further includes a bottom disk and a mounting cap detachably assembled with the bottom disk;
the bottom disk is provided with multiple limit slots and multiple pins mounted in the limit slots; and
the mounting cap is provided with an embedded section inserted into the second embedded portion.

9. The water filter as claimed in claim 8, wherein each of the pawls is received in one of the limit slots and has a first end pivotally mounted on one of the pins and a second end protruding from one of the limit slots, and each of the elastic plates is received in one of the limit slots and elastically biased between the bottom disk 1 and the second end of one of the pawls.

10. The water filter as claimed in claim 1, wherein the elastic support pieces form an arcuate C-shaped snap member.

11. The water filter as claimed in claim 1, wherein the pulling member is disposed between the tightening strap and the elastic support pieces.
